(19) United States
(12) Patent Application Publication
(10) Pub. No.: US 2013/0340485 A1
(43) Pub. Date: Dec. 26, 2013

(54) METHOD AND DEVICE FOR DETECTING AN IMBALANCE IN A LAUNDRY TREATMENT APPLIANCE

(71) Applicant: DIEHL AKO STIFTUNG & CO. KG, WANGEN (DE)

(72) Inventor: STEFAN ZEH, WANGEN (DE)

(21) Appl. No.: 13/927,649

(22) Filed: Jun. 26, 2013

(30) Foreign Application Priority Data
Jun. 26, 2012 (DE) 10 2012 012 701.4
Nov. 6, 2012 (DE) 10 2012 021 747.1

(51) Int. Cl. D06F 37/20; G05B 13/02; G01M 1/28

(52) U.S. Cl. CPC D06F 37/203; G01M 1/28; G05B 13/02
USPC 68/23.1; 73/457; 318/452

(57) ABSTRACT

A load of laundry that is distributed in an imbalanced manner in a laundry treatment appliance can lead to mechanical destruction at higher rotational speeds. A method for detecting an imbalance in a laundry treatment appliance which has a rotating drum and a drive system with electronic control system, a rotational speed or a variable linked with the rotational speed is acquired in the electronic control system as a rotational speed signal, the frequency component of the 2nd order in relation to the mechanical drum rotational speed is determined in the rotational speed signal that is acquired, and an imbalance in the drum is then detected if a value of the frequency component of the 2nd order that is determined exceeds a predetermined limiting value. The method is in particular also suitable for detecting a dynamic imbalance or in the case of laundry treatment appliances with a vertical axis of rotation.

### CROSS-REFERENCE TO RELATED APPLICATION

This application claims the priority, under 35 U.S.C. §119, of German patent applications DE 10 2012 012 701.4, filed Jun. 26, 2012, and DE 10 2012 021 747.1, filed Nov. 6, 2012; the prior applications are herewith incorporated by reference in their entirety.

### BACKGROUND OF THE INVENTION

### Field of the Invention

The present invention relates to a method and a device for detecting an imbalance in a laundry treatment appliance.

In laundry treatment appliances such as, for example, domestic washing machines and laundry dryers, a tub is usually mounted via springs and dampers in the stationary housing of the appliance such that it can swing, and a laundry drum is rotatably mounted in the interior of the tub. In order to dewater the laundry in the drum, the drum is accelerated to high rotational speeds, such as about 1600 rpm (rev/min), for example. The water is thus ejected from the laundry through the perforated drum wall by centripetal forces.

At laundry rotational speeds of about 50 rpm, the laundry is raised upwards with the drum movement and then falls down again on account of gravitation. When running up to spinning speed, beginning from a contact rotational speed of about 90 rpm, the centripetal force becomes greater than the gravitational force, so that the laundry then rests permanently on the drum circumference. Starting from the contact rotational speed, the laundry distribution on the circumference of the drum therefore remains unchanged.

In the event of an imbalanced distribution of the laundry, the swing-mounted tub can start moving and strike the stationary housing. This striking is to be ruled out, since possible mechanical damage can be caused thereby. In addition, the maximum rotational speed should be matched to the imbalance mass, in order to keep the forces on mechanical components within the permissible range.

Various possible ways of detecting an imbalance in a laundry treatment appliance are known from the prior art.

For example, there are appliances on the market in which impact sensors are incorporated or acceleration sensors are fitted to the tub. Likewise, displacement sensors which are able to detect vibrations and are integrated into the shock absorbers are known.

By way of example, reference is had, in this context, to United States Patent Application Publication Pub. No.: US 2006/0185097 A1 and its counterpart European Patent EP 1 693 499 B1, which disclose an internal unit suspended such that it can swing and belonging to a laundry treatment machine having a vibration sensor in the internal unit, and German published, unexamined patent application DE 38 12 371 A1, which discloses a method for measuring the laundry distribution in washing machines by using a temperature measurement in the vibration damping system.

However, the additional sensor hardware means additional costs and also an additional probability of failure of the appliance.

Another approach consists in evaluating the signals from the motor control system, which are present in any case. Laundry treatment appliances having a rotatable drum and a drive train for the drum usually have their rotational speed regulated by electronic control systems. An electronic control system is therefore present, to which a rotational speed signal proportional to the drum rotational speed is available. Various methods which use these signals that are present in any case to determine the imbalance are known.

German published, unexamined patent application DE 38 12 330 A1 and German Patent DE 40 38 178 C2 describe, by way of example, methods for measuring the laundry distribution or an imbalance in washing machines and spin dryers, in which, with a constant reference rotational speed, deviations in amplitude of the actual rotational speed in relation to the reference rotational speed are measured. United States Patent Publication Pub. No.: US 2001/0052265 A1 and its counterpart WO 00/31332 A1 evaluate the min-max values of the rotational control error at a previously defined reference rotational speed. German published, unexamined patent application DE 10 2010 053 104 A1 proposes a method for controlling the operation of a laundry treatment apparatus in which, in order to detect an imbalance, the variation over time of a phase angle of a rotational speed fluctuation is evaluated. United States Patent Application Publication Pub. No.: US 2005/0143940 A1 and its counterpart European Patent EP 1 525 349 B1 described a method for determining a characteristic value for the imbalance of a washing machine drum is disclosed, in which the power consumption of the drive motor of the washing machine drum is evaluated.

These conventional methods are suitable only for detecting static imbalance but not for detecting dynamic imbalance.

A static imbalance is illustrated by way of example in FIG. 2. The imbalance is characterized in that a center of mass 9 of the load is located at a distance 10 from the axis of rotation 8 of the drum 3. In the case of a substantially horizontal axis of rotation 8, the gravitational force on the center of mass 9, together with the distance 10 of the load 11 distributed in an imbalanced manner to the axis of rotation 8, leads to torque fluctuations. These torque fluctuations lead to a frequency component of the 1st order in the rotational speed signal.

A so-called “dynamic imbalance” is illustrated by way of example in FIG. 3. The imbalance is characterized in that, although the center of mass 9 is located on the axis of rotation 8 of the drum 3 despite the load 12a, 12b being distributed in an imbalanced manner, the moment of inertia tensor represents an ellipsoid and the axis of rotation 8 does not coincide with one of the three inertial axes. Since the center of mass 9 is located on the axis of rotation 8, no torque fluctuations are generated on account of the gravitation. However, the fact that the axis of rotation 8 does not coincide with one of the inertial axes causes angular accelerations on the axis of rotation 8, so that a tumbling movement (nutation) of the swing-mounted tub 1 can arise.

A dynamic imbalance 12a, 12b therefore likewise generates movements of the tub 1 and should be detected in order to avoid mechanical damage. The damped and sprung suspension of the tub 1 in the housing 2 of the laundry treatment appliance 20 acts primarily in the z direction but less in the y direction. Because of this asymmetrical damping of the movements of the tub 1, small torque fluctuations act on the drive train. However, these torque fluctuations are orders of magnitude smaller than the torque fluctuations on account of a comparatively critical static imbalance.

The fluctuations in the amplitude of the rotational speed signal of a dynamic imbalance that is dangerous for the mechanism correspond approximately to the fluctuations in the amplitude of a harmless static imbalance. Conventional methods which detect fluctuations in amplitude are therefore, so to speak, blind to dynamic imbalance. One problem with the conventional imbalance detection methods is that the dynamic imbalance is either transparent to them or that investment in additional sensors, for example in the form of acceleration or displacement sensors, is necessary.

### SUMMARY OF THE INVENTION

It is accordingly an object of the invention to provide a method and an improved device for imbalance detecting in a laundry treatment appliance which overcome the disadvantages of the heretofore-known devices and methods of this general type and which provide for method and a device that are also able to detect dynamic imbalances.

With the foregoing and other objects in view there is provided, in accordance with the invention, a method of detecting an imbalance in a laundry treatment appliance having a rotating drum and a drive system with an electronic control system, the method which comprises:

acquiring a rotational speed signal of a rotational speed or a variable linked with the rotational speed in the electronic control system;

determining a frequency component of the 2nd order in relation to the mechanical drum rotational speed in the rotational speed signal being acquired;

detecting an imbalance in the drum if a value of the frequency component of the 2nd order exceeds a predetermined limiting value.

The rotating drum can then be driven in accordance with a result of the detecting step so as to avoid knocking and damage to the machine.

In other words, the method according to the invention for detecting an imbalance in a laundry treatment appliance having a rotating drum and a drive system with electronic control system includes the steps of acquiring a rotational speed signal of a rotational speed or a variable linked with the rotational speed in the electronic control system; of determining the frequency component of the 2nd order in relation to the mechanical drum rotational speed in the rotational speed signal that is acquired; and of detecting an imbalance in the drum if a value of the frequency component of the 2nd order that is determined exceeds a predetermined limiting value.

The device according to the invention for detecting an imbalance in a laundry treatment appliance having a rotating drum and a drive system with electronic control system has an acquisition means for acquiring a rotational speed signal of a rotational speed or a variable linked with the rotational speed in the electronic control system; a determination means for determining the frequency component of the 2nd order in relation to the mechanical drum rotational speed in the rotational speed signal that is acquired; and a comparison means for comparing a value of the frequency component of the 2nd order that is determined with a predetermined limiting value.

The present invention is based on the observation that, when a dynamic imbalance in the drum is present, frequency components with twice the basic frequency occur in a rotational speed signal, and these frequency components of the 2nd order increase in a specific drum rotational speed range, for example in the range from about 100 rpm to about 200 rpm.

The frequency components of the 2nd order probably occur on account of the suspension of the tub. The tub is normally suspended in the vertical direction via a plurality of springs and frictional dampers. Thus, different damping of the tub movement in the vertical and in the horizontal direction takes place. The transfer of energy to the springs and dampers effects a change in the rotational energy of the drum and therefore a change in the rotational speed of the latter. Via the frictional dampers, energy is removed from the system both during downward and during upward movements. It is therefore possible to declare that frequency components of the 2nd order in relation to the drum rotational speed occur as soon as the drum starts moving as a result of static or dynamic imbalance.

In conventional domestic washing machines, the tub suspension has a resonance at a drum rotational speed of about 180 rpm. This means that excitation as a result of imbalance, in particular at this drum rotational speed, can lead to violent movements of the tub, and thus the frequency components of the 2nd order also rise sharply in this rotational speed range.

In accordance with an added feature of the invention, a rotational speed signal from the electronic control system of the drive system is analyzed and the frequency component of the 2nd order of the current mechanical drum rotation speed is determined, in order on this basis to be able to detect an imbalance, in particular a dynamic imbalance.

The method according to the invention particularly suitable for detecting a dynamic imbalance in the laundry treatment appliance and also for laundry treatment appliances having a vertical axis of rotation of the drum.

In the method according to the invention, a rotational speed signal is acquired in the electronic control system. This rotational speed signal contains information with respect to the rotational speed or a variable linked with the rotational speed. In the closed control loop of the electronic control system of the drive system, all the frequency components in the rotational speed signal are of course also transmitted to other signals, such as the torque set point, for example, and to the dependent variables of the motor drive system, such as the motor output power or the power consumption of the electronic control system, for example. Therefore, as an alternative to the analysis of rotational speed itself, an analysis of another variable—linked with the rotational speed—is also effective. The term “rotational speed signal” is consequently intended to comprise in particular signals which contain information regarding the rotational speed and also signals which contain information regarding a variable linked with the rotational speed.

The frequency components of the 2nd order can preferably be determined via a band-pass filter or by means of Fourier transformation or fast Fourier transformation (FFT). The possibilities of the signal processing known per se to those skilled in the art are not to be explained further here.

As is known, periodic functions can be represented by an (infinite) series of sine and cosine functions, the frequencies of which are integer multiples of the basic frequency. Given the presence of an imbalance, the result of low rotational speeds below the contact rotational speed—as a result of the alternate raising and falling of the laundry in the drum—is a periodic rotational speed signal, which can be developed into a Fourier series. The sine and cosine functions of the basic frequency are also designated as a 1st harmonic or frequency component of the 1st order in this connection; the sine and cosine functions of twice the basic frequency are also designated as the 1st harmonic wave, as the 2nd harmonic or as the frequency component of the 2nd order in this connection.

In a preferred refinement of the invention, when running up to spinning speed, the frequency component of the 2nd order is determined and evaluated continuously. As described above, in the presence of a dynamic imbalance in the drum, specifically in the low rotational speed range, a significant rise in the frequency component of the 2nd order occurs, so that detection of the dynamic imbalance is preferably carried out when running up to spinning speed and therefore at still non-critical rotational speeds.

In a further preferred refinement of the invention, an imbalance in the drum is detected when a relative value of the frequency component of the 2nd order that is determined, based on a frequency component of the 2nd order that is determined at a predetermined drum rotational speed or in a predetermined drum rotational speed range, exceeds a predetermined limiting value. By means of the evaluation of a relative value of the frequency component of the 2nd order that is determined, it is possible to compensate for any individual scattering or ageing-induced drift in the absolute value. Additionally or alternatively, it is also possible, according to the invention, to detect an imbalance when an absolute value of the frequency component of the 2nd order that is determined exceeds a predetermined limiting value.

In a further preferred refinement of the invention, upper limiting values of the drum rotational speed for values of the frequency component of the 2nd order at a predetermined, preferably non-critical drum rotational speed and/or for maximum values of the frequency component of the 2nd order in a predetermined, preferably non-critical drum rotational speed range are stored in a table. By means of this measure, the laundry treatment appliance can be protected better in that, when an upper limiting value of the drum rotational speed that is relevant to the respectively present imbalance is reached, running up to spinning speed is aborted.

In a still further refinement of the invention, the frequency component of the 1st order in relation to the mechanical drum rotational speed is also determined in the rotational speed signal that is acquired and is evaluated. In this way, in addition to a dynamic imbalance, a static imbalance can also be detected reliably and thus the protective action for the laundry treatment appliance can be improved.

The subject-matter of the invention is also a laundry treatment appliance such as, for example, a washing machine or laundry dryer having a rotating drum; a drive system with electronic control system; and a device according to the invention for detecting an imbalance in the laundry treatment appliance.

Other features which are considered as characteristic for the invention are set forth in the appended claims.

Although the invention is illustrated and described herein as embodied in a method and device for detecting an imbalance in a laundry treatment appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an equivalent circuit diagram of the rotational speed control loop of an electronic control system of a laundry treatment appliance according to the present invention;

FIG. 2 shows a schematic representation of a laundry treatment appliance to illustrate an example of a static imbalance;

FIG. 3 shows a schematic representation of a laundry treatment appliance to illustrate an example of a dynamic imbalance;

FIG. 4 shows a graph of the frequency components of the 1st order N1 and the 2nd order N2 with respect to the current mechanical drum rotational speed N in the rotational speed signal of the control loop for the case of a non-critical and purely static imbalance; and

FIG. 5 shows a graph of the frequency components of the 1st order N1 and the 2nd order N2 with respect to the current mechanical drum rotational speed N in the rotational speed signal of the control loop for the case of a dangerous dynamic imbalance.

### DETAILED DESCRIPTION OF THE INVENTION

The invention will be described in more detail with reference to the example of a washing machine having a drum with a substantially horizontal axis of rotation as an example of a laundry treatment appliance.

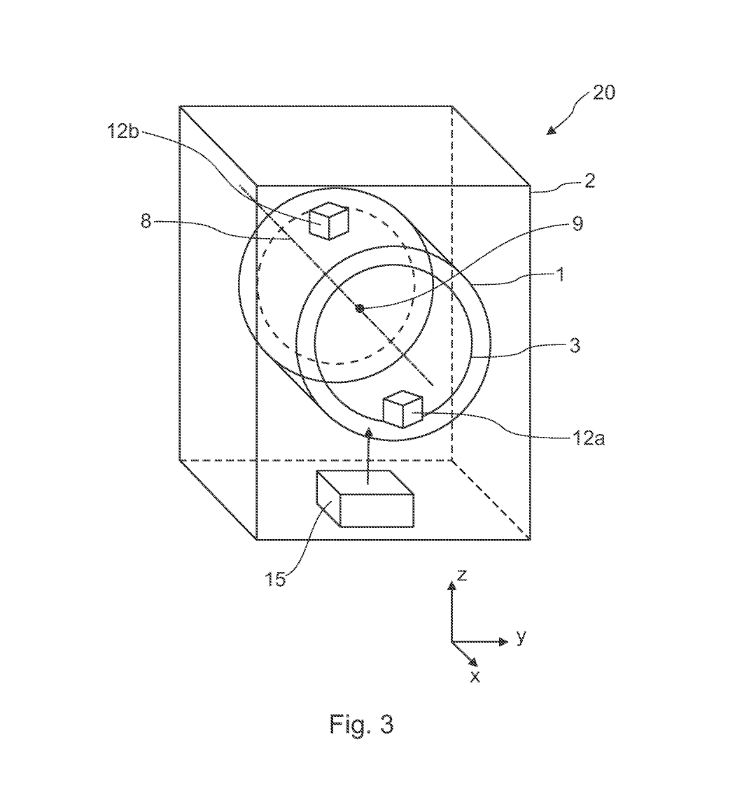

Referring now to the figures of the drawing in detail and first, particularly, to FIGS. 2 and 3, there is shown a washing machine 20 with a tub 1, which is mounted via springs and dampers (not illustrated) in a stationary housing 2 such that it can swing. A laundry drum 3 is rotatably mounted In the interior of this tub 1 about a substantially horizontal axis.

The laundry drum 3 is connected to a drive system 15, which in particular includes a drive motor for the drum 3 and an electronic control system.

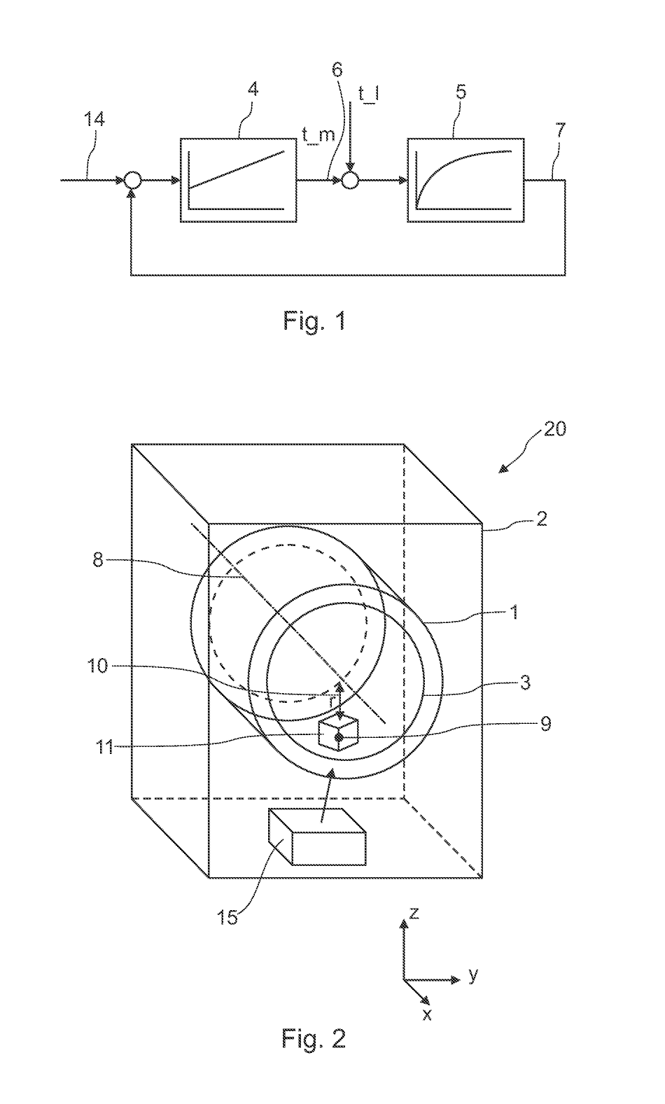

FIG. 1 shows, by way of example, a rotational speed control loop of the electronic control system of the drive system 15. This rotational speed control loop is normally mapped in software.

The control loop includes, in particular, a rotational speed controller 4, to which a rotational speed set point is fed as reference variable 14 and which, for example, outputs a torque set point t_m as actuating variable 6. The rotational speed controller 4, which is implemented in software, is illustrated in simplified form as a PI controller. The actuating variable 6 is fed to a control section 5—possibly influenced by an interference variable t_l on account, for example, of an imbalance-induced additional load through gravitation. The control section 5 of the control loop, which physically represents the drive train (i.e., an assembly comprising the rotating drum, a gearbox and a drive motor), is illustrated in simplified form as a PT1 element. It is characterized, for example, by a low-pass filter of the 1st order, which results from the moment of inertia and friction. The control variable output by the control section 5 is fed back to the input of the rotational speed controller 4.

According to the invention, it is proposed to analyze the rotational speed signal 7 which is available in any case as a controlled variable in the control loop of the electronic control system in any case and, in particular, to determine in the process the frequency component of the 2nd order N2 relating to the current mechanical drum rotational speed N. From this, conclusions can be drawn about any dynamic imbalance. The frequency components of the 2nd order N2 can, for example, be determined via a band-pass filter or by way of a Fourier transformation or a fast Fourier transformation (FFT).

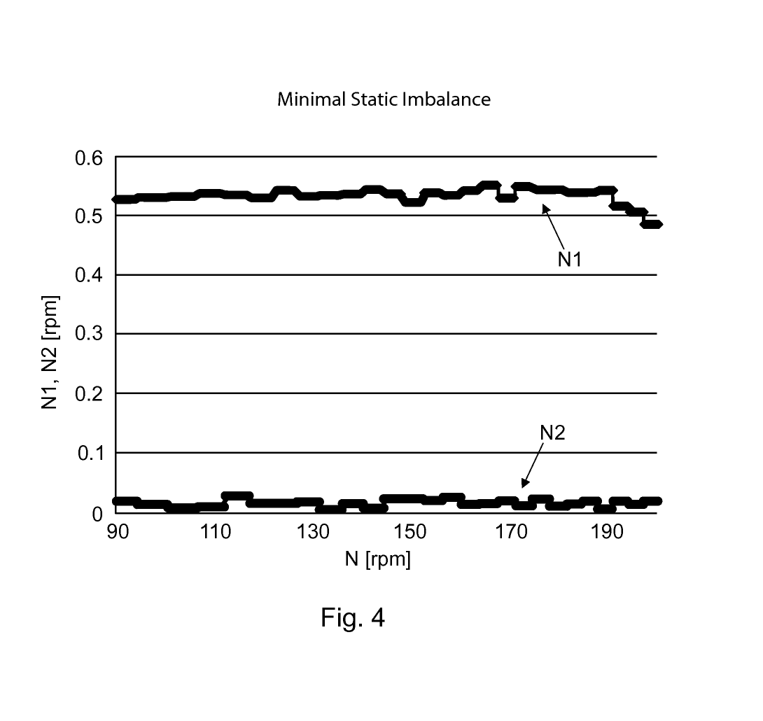

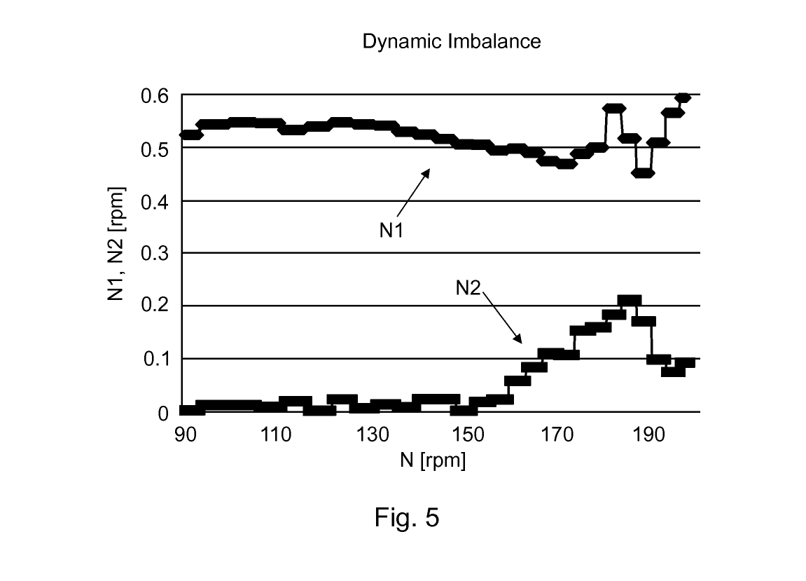

FIG. 4 and FIG. 5 illustrate the problem why measuring methods which are based solely on the evaluation of the amplitude of fluctuations in the rotational speed signal 7 are blind to dynamic imbalance.

FIG. 4 shows, within the control system software of the laundry treatment appliance, signals determined in real time of the frequency components of the 1st order N1 and the 2nd order N2 with respect to the current mechanical drum frequency in the rotational speed signal 7 of the control loop, plotted against the current, average mechanical drum rotational speed N. In FIG. 4, a case of a harmless load with a non-critical, minimal, low, purely static imbalance 11 of, for example, 200 g (cf. FIG. 2) is documented, which leads to a relatively small tub movement, and it is thus possible to run up to the maximum spinning rotational speed of, for example, about 1600 rpm. At the contact rotational speed of about 90 rpm, rotational speed deviations of about ±0.53 rpm (as a frequency component of the 1st order N1) are measured. In this case, on the other hand, significant frequency components of the 2nd order N2 do not occur.

FIG. 5 shows, likewise within the control system software of the laundry treatment appliance, signals determined in real time of the frequency components of the 1st order N1 and the 2nd order N2 with respect to the current mechanical drum frequency in the rotational speed signal 7 of the control loop, plotted against the current, average mechanical drum rotational speed N. In FIG. 5, however, the case is now illustrated in which the same harmless static imbalance 11 of about 200 g is present. However, in addition a load distribution of 1000 g in the form of a dynamic imbalance 12a of 500 g at the bottom front and 12b of 500 g at the top rear is present in the drum 3 (cf. FIG. 3). As a result of this dynamic imbalance, it is possible for impermissibly high tumbling movements of the drum 3 and therefore also of the tub 1 to occur, in particular in the resonant rotational speed range of, say, about 180 rpm. On account of the dynamic imbalance 12a, 12b, the drum 3 should therefore not be operated at rotational speeds higher than about 170 rpm, in order to protect the machine.

A conventional evaluation of the frequency component of the 1st order N1 of the rotational speed signal 7 in the non-critical case of FIG. 4 therefore results in virtually the same measured value as in the critical case of FIG. 5, so that in this evaluation the dangerous dynamic imbalance according to FIG. 3 would remain unnoticed.

In the case in which the frequency component of the 2nd order N2 is considered in accordance with the invention, it can be seen that, with a dynamic imbalance, the values of N2 rise significantly beginning at rotational speeds of greater than 160 rpm. Given evaluation of the frequency component of the 2nd order, without additional sensors, a dynamic imbalance can therefore also be detected reliably merely by way of an appropriate expansion of the software and, by way of an appropriate predefinition of the rotational speed set point, critical states for the mechanism of the laundry treatment appliance can be avoided.

The frequency component of the 2nd order N2 can be determined continuously as the speed is increased. A rotational speed choice can then be initiated when the value of this frequency component of the 2nd order exceeds a previously determined threshold value.

It is possible for a table which includes the upper rotational speed limit in the case of the current laundry distribution to be stored in the process engineering control system. The input variable of the table is the frequency component of the 2nd order N2 at a non-critical rotational speed of 150 rpm, for example.

It is also possible for a table which includes the upper rotational speed limit in the case of the current laundry distribution to be stored in the process engineering control system. The input variable of the table is the highest frequency component of the 2nd order N2 which has been measured in a certain rotational speed range, for example between 100 rpm and 150 rpm.

Since the absolute value of the frequency component of the 2nd order N2 is subject to individual scatter or ageing drift, the frequency component of the 2nd order N2 is preferably based on measured values and lower rotational speeds of, for example, about 90 rpm to about 130 rpm, and the multiplication factor at higher rotational speeds is assessed.

Vibrations on account of static imbalance are also represented in the frequency component of the 2nd order N2. In order to assess the magnitude of the total imbalance and therefore of the total tub movements, in principle the sole assessment of N2 would be sufficient. Since, however, the frequency component of the 1st order N1 resolves the effect of the static imbalance 11 very well, the frequency component of the 1st order N1 is preferably also calculated and criteria for the process engineering are likewise derived therefrom. It is thus possible for further tables with upper rotational speed limits which are based on the frequency component of the 1st order N1 to be created. The absolute upper rotational speed limit is then calculated, for example, from the minimum found in the different tables.

1. A method of detecting an imbalance in a laundry treatment appliance having a rotating drum and a drive system with an electronic control system, the method which comprises:
acquiring a rotational speed signal of a rotational speed or a variable linked with the rotational speed in the electronic control system;
determining a frequency component of the 2nd order in relation to the mechanical drum rotational speed in the rotational speed signal being acquired;
detecting an imbalance in the drum if a value of the frequency component of the 2nd order exceeds a predetermined limiting value; and
driving the rotating drum in accordance with a result of the detecting step.

2. The method according to claim 1, which comprises continuously determining the frequency component of the 2nd order while running the drum up to spinning speed.

3. The method according to claim 1, which comprises determining that an imbalance is present in the drum when a relative value of the frequency component of the 2nd order, based on a frequency component of the 2nd order that is determined at a predetermined drum rotational speed or in a predetermined rotational speed range, exceeds a predetermined threshold value.

4. The method according to claim 1, which comprises providing a table having stored therein upper limiting values of the drum rotational speed for values of the frequency component of the 2nd order at a predetermined drum rotational speed and/or for maximum values of the frequency component of the 2nd order in a predetermined drum rotational speed range.

5. The method according to claim 4, wherein the table has stored therein the upper limiting values of the drum rotational speed for values of the frequency component of the 2nd order at a non-critical drum rotational speed and/or for maximum values of the frequency component of the 2nd order in a non-critical drum rotational speed range.

6. The method according to claim 1, which further comprises determining a frequency component of the 1st order in relation to the mechanical drum rotational speed in the rotational speed signal being acquired in the acquiring step.

7. A device for detecting an imbalance in a laundry treatment appliance having a rotating drum and a drive system with an electronic control system, the device comprising:
an acquisition device for acquiring a rotational speed signal of a rotational speed or a variable linked with the rotational speed in the electronic control system;
a determination device connected to receive from said acquisition device the rotational speed signal and configured for determining the frequency component of the 2nd order in relation to the mechanical drum rotational speed in the rotational speed signal; and
a comparator device configured for comparing a value of the frequency component of the 2nd order determined by said determination device with a predetermined limiting value.

8. The device according to claim 7 configured for carrying out the method according to claim 1.

9. The device according to claim 7, wherein said comparator device is configured to compare a relative value of the frequency component of the 2nd order that is determined in relation to a frequency component of the 2nd order that is determined at a predetermined drum rotational speed or in a predetermined drum rotational speed range with a predetermined limiting value.

10. The device according to claim 7, which further comprises a storage device for storing a table containing upper limiting values of the drum rotational speed for values of the frequency component of the 2nd order at a predetermined drum rotational speed and/or for maximum values of the frequency component of the 2nd order in a predetermined drum rotational speed range.

11. The device according to claim 10, wherein the table contains upper limiting values of the drum rotational speed for values of the frequency component of the 2nd order at a non-critical drum rotational speed and/or for maximum values of the frequency component of the 2nd order in a non-critical drum rotational speed range.

12. The device according to claim 7, which comprises a further determination means for determining the frequency component of the 1st order in relation to the mechanical drum rotational speed in the rotational speed signal acquired by said acquisition device.

13. A laundry treatment appliance, comprising:
a rotatably mounted drum;
a drive system with an electronic control system for driving said rotatably mounted drum; and
a device connected to said drive system for detecting an imbalance in the laundry treatment appliance according to claim 7.
